(19) United States
(12) Patent Application Publication
(10) Pub. No.: US 2022/0300928 A1
(43) Pub. Date: Sep. 22, 2022

(54) Cloud Computing Metering and Charging Method and Apparatus, and Electronic Device and Storage Medium

(71) Applicant: Beijing Kingsoft Cloud Network Technology Co., Ltd., Beijing (CN)

(72) Inventors: Jianting Zhu, Beijing (CN); Guangrui Zhou, Beijing (CN); Yu Chen, Beijing (CN); Nan Chen, Beijing (CN)

(21) Appl. No.: 17/753,570

(22) PCT Filed: Nov. 19, 2020
(86) PCT No.: PCT/CN2020/130080

§ 371 Date: Mar. 8, 2022

(30) Foreign Application Priority Data
Dec. 12, 2019 (CN) 201911276941.7

(51) Int. Cl. G06Q 20/14; G06F 9/50; G06F 9/4401

(52) U.S. Cl. CPC G06Q 20/145; G06F 9/5072; G06F 9/5077; G06F 9/442

(57) ABSTRACT

A cloud computing metering and charging method and apparatus, and an electronic device and a computer readable storage medium. The method comprises: obtaining an identifier of a cloud host instance to be charged; obtaining, according to the identifier, a data record set corresponding to the identifier; for each data record, determining a charging duration according to an instance change time in the data record; and in the case that an instance change type in the data record is instance shutdown, performing charging processing on a charging item in instance configuration information according to the charging duration. By means of the method, minimization of bill expenses after the cloud host instance is shut down can be implemented, the use experience of users is improved.

The present application claims the priority to a Chinese patent application No. 201911276941.7 filed with the China National Intellectual Property Administration on Dec. 12, 2019 and entitled “cloud computing metering and charging method and apparatus, and electronic device and storage medium”, which is incorporated herein by reference in its entirety.

### TECHNICAL FIELD

The present application relates to the field of cloud computing system, and in particular, to a cloud computing metering and charging method and apparatus, and an electronic device and a storage medium.

### BACKGROUND

In related technologies, after a user opens a cloud host instance that is charged on demand, regardless of the running state of the host instance, as long as its configuration information does not change, the cloud host service provider will charge a same fee periodically until the user unsubscribes the host instance (also called instance release or instance deletion).

The cloud host using the EBS (Elastic Block Store) technology solution has achieved the separation of calculation and storage. When the cloud host is shut down, its occupied CPU (central processing unit), memory and other computing resources have been released for the use by other cloud host instances, meanwhile the corresponding physical machine can also use the CPU, memory and other computing resources released by the cloud host instance to virtualize more cloud host instances to increase the sales ratio of the physical machine. In this case, the cloud host service provider still charges a same fee regularly according to the configuration information corresponding to the cloud host instance; however, the user does not actually use the corresponding computing resources at the time. This is very unfair to users, and it is not conducive to sales for the manufacturers themselves because some cost-sensitive users will unsubscribe the entire cloud host when they need to shut it down, and re-order a cloud host when they need to restart it and reinstall all the software systems that need to be used. However, the experience of this operation is extremely poor for the user, and the user is likely to give up using the vendor's cloud hosting service.

### SUMMARY

An objective of the present application is to provide a metering and charging method and apparatus for cloud computing, an electronic device and a computer readable storage medium, so as to minimize billing fees after the cloud host instance is shut down, thus improving the use experience of users.

According to a first aspect of the present application, a metering and charging method for cloud computing is provided, which includes: obtaining an identifier of a cloud host instance to be charged; obtaining, according to the identifier, a data record set corresponding to the identifier; wherein each data record included in the data record set includes instance configuration information, instance change time, and instance change type of the cloud host instance; for each data record, determining a charging duration according to the instance change time in the data record; and in the case that the instance change type in the data record is instance shutdown, performing charging processing on charging items in the instance configuration information according to the charging duration, wherein the charging items do not include charging items corresponding to computing resources.

According to a second aspect of the present application, a cloud computing metering and charging apparatus is provided, which comprises: a first obtaining module, configured to obtain an identifier of a cloud host instance to be charged; a second obtaining module, configured to obtain, according to the identifier, a data record set corresponding to the identifier; wherein each data record included in the data record set includes instance configuration information, instance change time, and instance change type of the cloud host instance; a determining module, configured to determine, for each data record, a charging duration according to the instance change time in the data record; and a charging module, configured to perform charging processing on charging items in the instance configuration information according to the charging duration in the case that the instance change type in the data record is instance shutdown, wherein the charging items do not include charging items corresponding to computing resources.

According to a third aspect of the present application, an electronic device is provided, which comprises: a processor and a memory, the memory is configured to store executable instructions, and the instructions are used to control the processor to execute the metering and charging method for cloud computing according to the first aspect of the present application.

According to a fourth aspect of the present application, a computer-readable storage medium is provided, on which a computer program is stored, the computer program, when executed by a processor, implements the metering and charging method for cloud computing according to the first aspect of the present application.

According to the embodiment of the present application, data records containing the corresponding instance change time and instance change type of the cloud host instance are obtained, and the corresponding charging duration is obtained according to the instance change time. Based on the charging duration, the computing resources of the cloud host instance whose instance change type is instance shutdown are no charged. In such a way, users who are sensitive to costs do not need to unsubscribe the cloud host instance when they want to shut down the instance, nor do they need to re-order and re-install all software systems when they want to restart it, such that the users can really shut it down when they want to shut down, and restart it when they want to restart, thus minimizing the bill fees for users to use cloud host instances. This not only improves the user experience, but also enables cloud host providers to attract more users, and maintain and improve the sales of storage and network resources while maximizing the sales ratio of physical machines.

Through the following detailed description of exemplary embodiments of the present application with reference to the accompanying drawings, other features and advantages of the present application will become clear.

### BRIEF DESCRIPTION OF THE DRAWINGS

The drawings incorporated in the specification and constituting a part of the specification illustrate the embodiments of the present application, and together with the description are used to explain the principle of the present application.

FIG. 1 is a structural block diagram of a hardware configuration that can be used to implement an electronic device provided by an embodiment of the present application;

FIG. 2 is a flowchart of the steps of a metering and charging method for cloud computing provided by an embodiment of the present application;

FIG. 3 is a diagram of a specific example of a metering and charging method for cloud computing provided by an embodiment of the present application;

FIG. 4 is a structural block diagram of a cloud computing metering and charging apparatus provided by an embodiment of the present application;

FIG. 5 is a structural block diagram of an electronic device provided by an embodiment of the present application.

### DETAILED DESCRIPTION OF THE INVENTION

Various exemplary embodiments of the present application will now be described in detail with reference to the accompanying drawings. It should be noted that unless specifically stated otherwise, the relative arrangement, numerical expressions and numerical values of the components and steps set forth in these embodiments do not limit the scope of the present application.

The following description of at least one exemplary embodiment is actually merely illustrative, and in no way serves as any restriction on the present application and its application or use.

The technologies, methods, and equipment known to persons of ordinary skill in the relevant fields may not be discussed in detail, but where appropriate, the technologies, methods, and equipment should be regarded as part of the specification.

In all examples shown and discussed herein, any specific value should be interpreted as merely exemplary, rather than as a limitation. Therefore, other examples of the exemplary embodiment may have different values.

It should be noted that similar reference numerals and letters indicate similar items in the following drawings. Therefore, once an item is defined in one drawing, it does not need to be further discussed in the subsequent drawings.

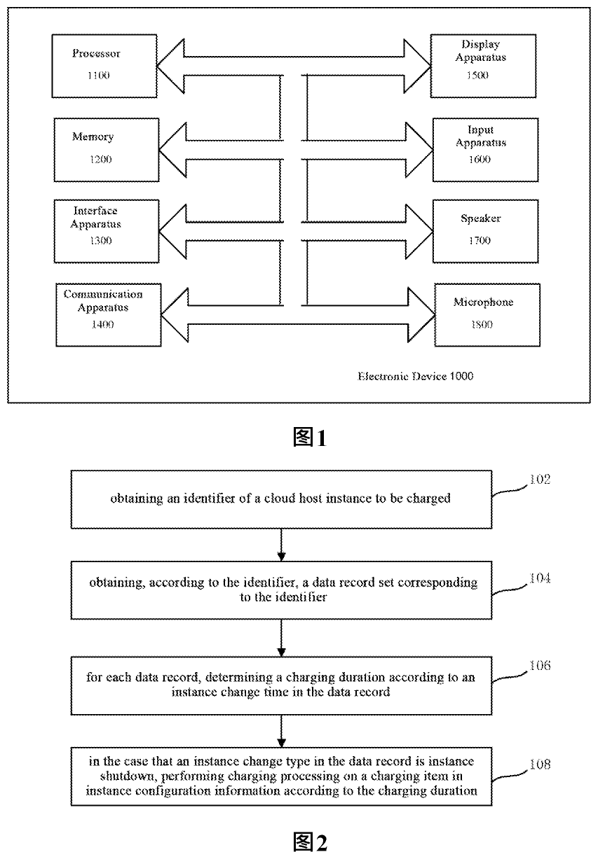

FIG. 1 is a structural block diagram illustrating a hardware configuration that can be used to implement an electronic device 1000 provided by an embodiment of the present application.

The electronic device 1000 may be a portable computer, a desktop computer, a mobile phone, a tablet computer, and the like.

As shown in FIG. 1, the electronic device 1000 may comprise a processor 1100, a memory 1200, an interface apparatus 1300, a communication apparatus 1400, a display apparatus 1500, an input apparatus 1600, a speaker 1700, a microphone 1800, and so on. The processor 1100 may be a central processing unit (CPU), a microprocessor (MCU), or the like. The memory 1200 may refer to a non-volatile memory, such as a ROM (Read-Only Memory), a hard disk, etc., or may refer to a volatile memory, such as a RAM (Random Access Memory). The interface apparatus 1300 comprises, for example, a USB interface, a headphone interface, and the like. The communication apparatus 1400, for example, can perform wired or wireless communication including Wi-Fi communication, Bluetooth communication, 2G/3G/4G/5G communication, and the like. The display apparatus 1500 is, for example, a liquid crystal display, a touch display, or the like. The input apparatus 1600 may comprise, for example, a touch screen, a keyboard, a somatosensory input, and the like. The electronic device 1000 may output voice messages through the speaker 1700, and the user may input voice information through the microphone 1800.

The electronic device shown in FIG. 1 is merely illustrative and in no way implies any restriction on the present application, its application or usage. In the embodiments of the present application, the memory 1200 of the electronic device 1000 is configured to store instructions for controlling the processor 1100 to execute any of metering and charging methods for cloud computing provided in the embodiments of the present application, that is, when the instructions are executed by the processor 1100, the processor 1100 will implement any one of the metering and charging methods for cloud computing provided in the embodiments of the present application. Those skilled in the art should understand that although multiple apparatuses are shown for the electronic device 1000 in FIG. 1, the present application may only involve some of these apparatuses. For example, the electronic device 1000 may only involve the processor 1100 and the storage apparatus 1200. The skilled person can design instructions according to the solution disclosed in the present application. How the instructions control the operation of the processor is well known in the art and will not be described in detail herein.

In an embodiment of the present application, a metering and charging method for cloud computing is provided.

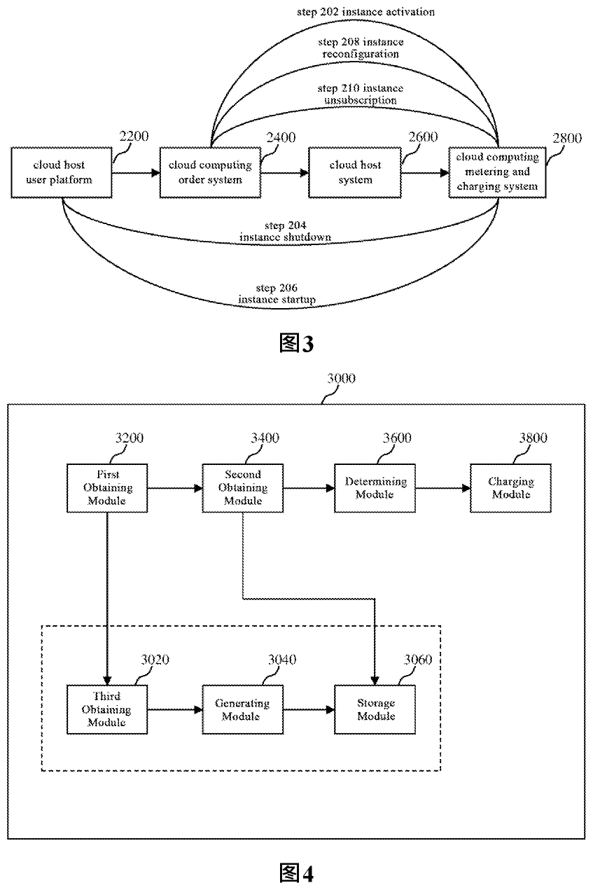

Referring to FIG. 2, FIG. 2 is a flowchart of the steps of a metering and charging method for cloud computing provided by an embodiment of the application. The metering and charging method for cloud computing may be implemented by an electronic device. The electronic device may be, for example, the electronic device 1000 shown in FIG. 1, or it may be implemented by other electronic devices other than the electronic device 1000 shown in FIG. 1. The metering and charging method for cloud computing provided by the embodiment of the application may be implemented by one electronic device alone, or implemented jointly by multiple electronic devices, which is not limited in this embodiment.

As shown in FIG. 2, the metering and charging method for cloud computing provided by the embodiment of the present application may include the following steps:

Step 102: obtaining an identifier (ID) of a cloud host instance to be charged;

Step 104: obtaining a data record set corresponding to the identifier according to the identifier; wherein each data record included in the data record set includes instance configuration information, instance change time, and instance change type of the cloud host instance;

Step 106: for each data record, determining a charging duration according to the instance change time in the data record;

Step 108: in the case that the instance change type in the data record is instance shutdown, performing charging processing on charging items in the instance configuration information according to the charging duration, wherein the charging items do not include charging items corresponding to computing resources.

In an example, before obtaining the identifier of the cloud host instance to be charged, the metering and charging method for cloud computing may further include: obtaining the identifier of the cloud host instance, instance configuration information, instance change time and instance change type, generating the record data according to the identifier, the instance configuration information, the instance change time, and the instance change type, and storing the data record.

The data record include, but are not limited to, the identifier of the cloud host instance, the instance change time, the instance configuration information, and the instance change type corresponding to different change operations.

The different change operations include, but are not limited to, at least one of instance activation operations, instance shutdown operations, instance startup operations, instance reconfiguration operations, and instance unsubscription operations.

Corresponding to the different change operations, the instance change types include at least one of instance activation, instance shutdown, instance startup, instance reconfiguration, and instance unsubscription.

Correspondingly, the instance change time includes at least one of: activation time of the instance, shutdown time of the instance, startup time of the instance, reconfiguration time of the instance, and unsubscription time of the instance.

Correspondingly, the instance configuration information includes one of the following: configuration information selected by the user when the instance is activated; the instance configuration information in the data record with the latest instance change time obtained by querying with the identifier of the cloud host instance as a key when the user shuts down the cloud instance; the instance configuration information in the data record with the latest instance change time obtained by querying with the identifier of the cloud host instance as a key when the user starts up the cloud instance; the configuration information of the cloud host instance after reconfiguration; and the configuration information being a null value.

In an example, the instance configuration information of the cloud host includes, but is not limited to, the configuration information corresponding to the charging items such as CPU, memory, disk, network, etc. For example, the configuration of the cloud host is as follows: CPU 1 core, memory 2G, disk 100G, network 1M fixed bandwidth, etc.

The computing resources include the CPU and memory of the cloud host instance, and the computing resources are released as the cloud host shuts down.

Disk and network bandwidth are non-computing resources. Disk is a storage resources, and network bandwidth is a network resources, both of which are non-computing resources and will not be released when the cloud host is shut down, and they are still occupied by users who subscribe to the resource.

For different instance change types corresponding to different change operations, the method of generating the stored data records may also be different. The details are as follows.

In the case that the instance change type is instance activation, a data record is generated with the identifier of the cloud host instance as the key, the configuration information of the cloud host instance that has been successfully activated as the value, the instance activation time as the instance change time, and the instance activation as the instance change type.

In the case that the instance change type is instance shutdown, a data record is generated with the identifier of the cloud host instance as the key, the instance configuration information as the value, the instance shutdown time as the instance change time, and the instance shutdown as the instance change type, wherein the instance configuration information is the instance configuration information in the data record with the latest instance change time obtained by querying a local database based on the identifier.

In the case that the instance change type is instance startup, a data record is generated with the identifier of the cloud host instance as the key, the instance configuration information as the value, the instance startup time as the instance change time, and the instance startup as the instance change type, wherein the instance configuration information is the instance configuration information in the data record with the latest instance change time obtained by querying the local database based on the identifier.

In the case that the instance change type is the instance reconfiguration, a data record is generated with the identifier of the cloud host instance as the key, the instance configuration information as the value, the instance configuration change time as the instance change time, and the instance reconfiguration as the instance change type.

In the case that the instance change type is instance unsubscription, a data record is generated with the identifier of the cloud host instance as the key, the instance configuration information as the value, the instance unsubscription time as the instance change time, and the instance unsubscription as the instance change type, the instance configuration information is a null value.

In one example, obtaining the instance configuration information of the cloud host instance includes: in the case that the instance change type is instance activation or instance change, obtaining the instance configuration information through an order server; in the case that the instance change type is instance startup or instance shutdown, querying the local database with the identifier to obtain a data record with the latest instance change time, and using the instance configuration information in the data record with the latest instance change time as the instance configuration information.

In the present application, the computing resources whose instance change type is instance shutdown are not charged, and the computing resources whose instance change type is instance activation, instance startup, or instance reconfiguration are still charged.

In the case that the instance change type is instance shutdown, in an example, the charging steps are as follows:

querying the data record with the latest instance change time among all data records whose instance change time is prior to or equal to a start time of the billing period according to the identifier of the cloud host instance;

querying all data records whose instance change time is later than the start time of the billing period according to the identifier of the cloud host instance;

calculating a difference between the instance change times corresponding to every two adjacent data records in the data records obtained by the query; and

using the difference as a charging duration, charging each charging item expect the computing resources in the instance configuration information of the data record in the two adjacent data records whose instance change time is prior and instance change type is instance shutdown. That is, for the data record in the two adjacent data records whose instance change time is prior and instance change type is instance shutdown, only charging items other than computing resources in the instance configuration information of this data record are charged.

In a possible embodiment, the calculation of the start time and the charging end time during charging can be determined in the following manner:

for charging start time, it can be to determine whether the instance change time in the data record is prior to a start time of a previous billing period. If the instance change time in the data record is prior to the start time of the previous billing period, the start time of the previous billing period is determined as the charging start time; if the instance change time in the data record is later than or equal to the start time of the previous billing period, the instance change time in the data record is determined as the charging start time.

For the charging end time, a data record in the data record set with an instance change time later than the instance change time of the data record and with the earliest instance change time in the data record set is determined as the second data record, and the instance change time in the second data record is determined as the charging end time.

The difference between the charging end time and the charging start time is determined as the charging duration, thus charging can be performed according to the charging duration.

For the case where the instance change type is instance activation, instance startup, or instance reconfiguration, in an example, the charging steps are as follows:

querying the data record with the latest instance change time among all data records whose instance change time is prior to or equal to the start time of the billing period according to the identifier of the cloud host instance;

querying all data records whose instance change time is later than the start time of the billing period according to the identifier of the cloud host instance;

calculating a difference between the instance change times corresponding to every two adjacent data records in the data records obtained by the query; and

using the difference as the charging duration, charging each charging item including computing resources in the instance configuration information of the data record in the two adjacent data records whose instance change time is prior.

According to the data records, different charging is performed on computing resources corresponding to different change operations.

For the case that the instance change type is instance unsubscription, since no new instance change records will appear in the future, all charging items of the instance including computing resources will no longer be charged.

In the following, a specific description of the metering and charging method for cloud computing of the present application will be given in conjunction with FIG. 3. FIG. 3 is a diagram of a specific example of the metering and charging method for cloud computing in an embodiment of the application.

The metering and charging method for cloud computing of the present application involves three main parts: a cloud computing order system 2400, a cloud computing metering and charging system 2800, and a cloud host system 2600. The process is as follows:

In combination with the above three system parts, the following process will explain five situations in which a user performs an activation operation, shutdown operation, startup operation, reconfiguration operation, and unsubscription operation on a corresponding cloud host instance through the cloud host user platform 2200.

(1) Step 202: Activation Operation of Cloud Host Instance

When a user places an order for a cloud host with the corresponding configuration on the cloud host user platform 2200, such as a cloud host tenant console, or when the user places an order for a cloud host with the corresponding configuration by calling the open platform OpenAPI (open programming interface) that creates the cloud host, the cloud host tenant console or the cloud host OpenAPI system (cloud host user platform 2200) synchronizes the configuration information of the cloud host (including but not limited to the configuration information corresponding to the charging items such as CPU, memory, disk, network, etc., such as CPU 2 cores, memory 4G, disk 200G, network 10M fixed bandwidth) to the cloud computing metering and charging system 2600 through the cloud computing order system 2400, which can include the following steps:

a) the cloud host user platform 2200 sends the configuration information selected by the user to the server (order server) of the cloud computing order system 2400 through the interface of the cloud computing order system 2400;

b) after processing the order payment business logic, the server of the cloud computing order system 2400 notifies the cloud host system 2600 to execute the instance activation operation of the cloud host with corresponding configuration, and after the cloud host system 2600 returns the execution result of the instance activation operation, it sends the configuration information of the successfully activated cloud host instance, the identifier of the instance, and the instance activation time to the cloud computing metering and charging system 2800;

c) the cloud computing metering and charging system 2800 stores the received instance identifier, configuration information, instance activation time and other information of the cloud host instance into a local database (each record of the database includes but is not limited to key fields such as the instance identifier, instance configuration, instance change time, and instance change type, wherein, the instance change type includes five types: instance activation, instance reconfiguration, instance shutdown, instance startup, and instance unsubscription). For example, using the instance identifier as the key, the configuration information as the value, the instance activation time as the instance change time, and the instance activation as the instance change type to generate a new data record for storage.

(2) Step 204: Shutdown Operation of Cloud Host Instance

When a user shuts down the corresponding cloud host instance through the cloud host user platform 2200, the cloud host user platform 2200 directly sends the instance identifier, successful shutdown time of the cloud host instance and other information to the cloud computing metering and charging system 2800 after the corresponding cloud host instance is successfully shut down, and the metering and billing system 2800 performs the following processing:

a) using the instance identifier as the key, querying and obtaining the data record with the longest instance change time from the database of the above-mentioned metering and charging system 2800. For example, it can be the following: when the instance changes, before the current data record is stored, the record with the longest instance change time queried with the instance identifier as the key is a record stored after the latest instance change. Obtaining its configuration information is to read the instance configuration information before this change (shutdown operation).

b) using the instance identifier as the key, the instance configuration information in the data record obtained by the aforementioned query (that is, the configuration information corresponding to the data record with the latest instance change time obtained by the query) as the value, the successful shutdown time as the instance change time, and the instance shutdown as instance change type to generate a new data record for storage.

(3) Step 206: Startup Operation of Cloud Host Instance

When a user starts up the corresponding cloud host instance through the cloud host user platform 2200, the cloud host user platform 2200 directly sends the instance identifier, successful startup time of the cloud host instance and other information to the cloud computing metering and charging system 2800 after the corresponding cloud host instance is successfully started up, and the cloud computing metering and charging system 2800 performs the following processing:

a) using the instance identifier as the key, querying and obtaining the data record with the longest instance change time from the database of the above-mentioned cloud competing metering and charging system 2800. For example, it can be the following: when the instance changes, before the current data record is stored, the record with the longest instance change time queried with the instance identifier as the key is a record stored after the latest instance change. Obtaining its configuration information is to read the instance configuration information before this change (startup operation).

b) using the instance identifier as the key, the instance configuration information in the data record obtained by the aforementioned query (that is, the configuration information corresponding to the data record with the latest instance change time obtained by the query) is used as the value, the successful startup time as the instance change time, and the instance startup as instance change type to generate a new data record for storage.

(4) Step 208 Reconfiguration Operation of Cloud Host Instance

When a user upgrades or downgrades the configuration of a cloud host instance through the cloud host user platform 2200, the cloud host user platform 2200 synchronizes identifier and changed configuration information of the instance, and change time to the cloud computing metering and charging system 2800 through the cloud computing order system 2400, which includes the following steps:

a) the cloud host user platform 2200 sends the changed configuration information of the instance to the server of the cloud computing order system 2400 through the interface of the cloud computing order system 2400;

b) after processing the order payment business logic, the server of the cloud computing order system 2400 notifies the cloud host system 2600 to perform the configuration change operation of the corresponding cloud host instance, and after the cloud host system 2600 returns the execution result of the instance configuration change operation, the server sends the instance identifier, the changed configuration information, the configuration change time and other information of the cloud host instance whose configuration has been successfully changed to the cloud computing metering and charging system 2800.

The cloud computing metering and charging system 2800 uses the instance identifier as the key, the changed configuration information as the value, the configuration change time as the instance change time, and the instance reconfiguration as the instance change type to generate a new data record for storage.

(5) Step 210: Unsubscription Operation of Cloud Host Instance

When a user unsubscribes the corresponding cloud host instance through the cloud host user platform 2200, the following steps are included:

a) the cloud host user platform 2200 sends instance identifier of the instance to be unsubscribed to the server of the cloud computing order system 2400 through the interface of the cloud computing order system 2400;

b) after processing the order-level business logic, the server of the cloud computing order system 2400 notifies the cloud host system 2600 to execute shutdown processing of the corresponding cloud host instance, and sends the instance identifier and instance unsubscription time to the cloud computing metering and charging system 2800;

c) the cloud computing metering and charging system 2800 uses the instance identifier as the key, the null value as the value, the instance unsubscription time as the instance change time, and the instance unsubscription as the instance change type to generate a new data record for storage.

As can be seen from the above, in steps 202, 208, and 210, the cloud computing order system 2400 sends information such as identifier, instance change time, and instance configuration information of the cloud host instance to the cloud computing metering and charging system 2800; in steps 204, 206, the cloud host user platform 2200 directly sends information such as the identifier and the instance change time of the cloud host instance to the cloud computing metering and charging system 2800.

In the following, the corresponding cloud computing metering and charging under five cases of activation operation, shutdown operation, startup operation, reconfiguration operation, and unsubscription operation will be described in conjunction with the cloud computing metering and charging system 2800.

When the cloud computing metering and charging system 2800 issues a bill on a regular basis (usually every few hours, such as 1 hour), it first obtains the complete set of identifiers of all instances to be charged, and performs metering and charging for each instance in the complete set of instance identifiers in the following manner:

a) using the instance identifier of the instance to be charged as the key, querying the data record with the longest instance change time among all data records whose instance change time is prior to or equal to the start time of the previous billing period (as an example, if a bill is issued every 1 hour, the start time of the previous billing period can be the previous hour 0 minutes 0 seconds, such as 2019-09-30 13:00:00), there is only one data record with the longest instance change time;

b) using the instance identifier of the instance to be charged as the key to query all data records whose instance change time is later than the start time of the previous billing period;

c) sorting all data records obtained in steps a) and b) in an ascending order of instance change time to obtain a new data record set, then traversing each data record in the set, and performing the following charging processing during the traversal process:
c1) using a first data record in the ascending order of the data record set as a first data record, and using instance change time in the first data record as a charging start time; and using start time of the previous billing period as a charging start time if the instance change time is prior to the start time of the previous billing period;
c2) using a next data record of the first data record in the data record set (that is, a record with instance change time later than the instance change time of the first data record and with the earliest instance change time) as a second data record, and using the instance change time of the second data record as a charging end time; the first data record and the second data record being adjacent data records;
c3) if the instance change type in the first data record is instance unsubscription, continuing a next traversal operation; in other words, when unsubscribing the instance, all charging items of the instance will no longer be charged;
c4) if the instance change type in the first data record is any one of instance activation, instance reconfiguration, and instance startup, using the difference between the charging end time and the charging start time as a charging duration, charging each charging item in the instance configuration information in the first data record respectively (the measurement value of the charging item is a configuration value corresponding to each charging item in the instance configuration information, and charging unit price is determined by a product pricing system provided by the cloud computing provider) to generate detailed data of each charging item, and adding the costs of each charging item to obtain the total cost of the instance in the current charging time period;
c5) if the instance change type in the first data record is instance shutdown, then each charging item in the instance configuration information in the first data record being processed as follows:
   c5-i) for charging items of computing resource such as CPU and memory, they are directly treated as non-charging, that is, the cost item in the cost detail data of charging items is 0 yuan;
   c5-ii) for charging items of non-computing resource such as storage and network, performing charging according to step c4);

d) after the charging of each instance change record in the data record set of the instance is finished, summing the subtotal cost in all charging time periods to obtain the total cost of the instance in the previous billing period.

For different change operations, the present application stores the current configuration information (or configuration after reconfiguration) of the instance and the time point of the event, and performs different charge processing for different change operations according to the stored data records.

By obtaining data records containing the corresponding instance change time and instance change type of the cloud host instance, and obtaining corresponding charging duration according to the instance change time, the computing resources of the cloud host instance whose instance change type is instance shutdown are not charged based on the charging duration. During charging, the present application can obtain data records related to the current billing period for charging according to the order of occurrence of events; during charging, the charging items of computing resources such as CPU and memory are not charged for the period between shutdown and restart of each instance, and other charging items are charged normally.

After the cloud host instance is shut down, the corresponding CPU, memory and other computing resources will no longer be charged, but the corresponding storage and network resources will continue to be charged, so that cost-sensitive users do not need to unsubscribe the cloud host instance when they want to shut down the instance, and they do not need to re-order and re-install all software systems when they want to start up the instant again, so that the users can really shut down the instance when they want to shut down the instance, and start up the instance again when they want to start up the instance, thus minimizing costs.

For manufacturers, on the one hand, it can attract more users (especially cost-sensitive users). On the other hand, it can also maintain and improve the sales of storage and network resources while maximizing the sales ratio of physical machines.

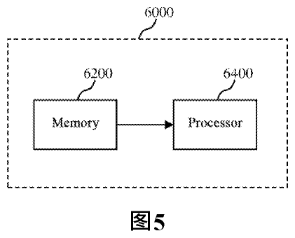

In another embodiment of the present application, a cloud computing metering and charging apparatus 3000 is also provided. As shown in FIG. 4, FIG. 4 is a structural block diagram of a cloud computing metering and charging apparatus according to an embodiment of the present application.

The cloud computing metering and charging apparatus 3000 includes a first obtaining module 3200, a second obtaining module 3400, a determining module 3600, and a charging module 3800. The first obtaining module 3200 obtains an identifier of a cloud host instance to be charged, and the second obtaining module 3400 is configured to obtain, according to the identifier, a data record set corresponding to the identifier, wherein each data record included in the data record set includes instance configuration information, instance change time, and instance change type of the cloud host instance.

The determining module 3600 is configured to determine, for each data record, a charging duration according to the instance change time in the data record. The charging module 3800 is configured to perform charging processing on charging items in the instance configuration information according to the charging duration in the case that the instance change type in the data record is instance shutdown, wherein the charging items do not include charging items corresponding to computing resources.

In an example, the computing resources include at least one of CPU and memory of the cloud host instance, and the instance change type includes at least one of instance activation, instance shutdown, instance startup, instance reconfiguration, and instance unsubscription.

In an example, when the determining module 3600 determines the charging duration according to the instance change time, it first determines whether the instance change time in the data record is prior to the start time of the previous billing period. If the result of the determination is that the instance change time in the data record is prior to the start time of the previous billing period, the start time of the previous billing period is determined as the charging start time. If the result of the determination is that the instance change time in the data record is later than or equal to the start time of the previous billing period, the instance change time in the data record is determined as the charging start time.

The determining module 3600 determines a data record in the data record set with an instance change time later than the instance change time of the data record and with the earliest instance change time in the data record set as a second data record, and determines the instance change time in the second data record as the charging end time, and determines the difference between the end time and the charging start time as the charging duration.

In an example, the cloud computing metering and charging apparatus 3000 further comprises a third obtaining module 3020, configured to obtain an identifier, instance configuration information, an instance change time and instance change type of the cloud host instance; a generating module 3040, configured to generate a data record according to the identifier, the instance configuration information, the instance change time and the instance change type; a storage module 3060, configured to store the data record.

When the third obtaining module 3020 obtains the instance configuration information of the cloud host instance, in the case that the instance change type is instance activation or instance reconfiguration, the third obtaining module obtains the instance configuration information through an order server; in the case that the instance change type is instance startup or instance shutdown, the third obtaining module queries a local database with the identifier to obtain a data record with the latest instance change time, and uses instance configuration information in the data record with the latest instance change time as the instance configuration information.

In an example, the first obtaining module 3200 may obtain the corresponding identifier of the cloud host instance to be charged from the data obtained by the third obtaining module 3020, and the second obtaining module 3400 may obtain the identifier from the storage module 3060 to obtain the corresponding data record set.

For different instance change types, the manner for generating module 3040 to generate a data record is as follows:

In an example, in the case that the instance change type is instance activation, the generating module 3040 uses the identifier of the cloud host instance as a key, the configuration information of the successfully activated cloud host instance as a value, the instance activation time as an instance change time, and instance activation as the instance change type to generate a data record.

In an example, in the case that the instance change type is instance shutdown, the generating module 3040 uses the identifier of the cloud host instance as a key, the instance configuration information as a value, an instance shutdown time as the instance change time, and instance shutdown as the instance change type to generate a data record, wherein the instance configuration information is instance configuration information in a data record with the latest instance change time obtained by querying a local database based on the identifier.

In an example, in the case that the instance change type is instance startup, the generating module 3040 uses the identifier of the cloud host instance as a key, the instance configuration information as a value, an instance startup time as the instance change time, and instance startup as the instance change type to generate a data record, wherein the instance configuration information is instance configuration information in a data record with the latest instance change time obtained by querying the local database based on the identifier.

In an example, in the case that the instance change type is instance reconfiguration, the generating module 3040 uses the identifier of the cloud host instance as a key, the instance configuration information as the value, an instance reconfiguration time as the instance change time, and instance reconfiguration as the instance change type to generate a data record.

In an example, in the case that the instance change type is instance unsubscription, the generating module 3040 uses the identifier of the cloud host instance as a key, the instance configuration information as a value, an instance unsubscription time as the instance change time, and instance unsubscription as the instance change type to generate a data record, the instance configuration information is a null value.

According to yet another embodiment of the present application, an electronic device is provided. The electronic device 6000 can be the electronic device 1000 illustrated in FIG. 1. FIG. 5 is a structural block diagram of an electronic device according to an embodiment of the present application.

On one hand, the electronic device 6000 can comprise the above-mentioned cloud computing metering and charging apparatus for implement any of the metering and charging methods for cloud computing in any embodiment of the present application.

On the other hand, as illustrated in FIG. 5, the electronic device 6000 may comprise a memory 6200 and a processor 6400, the memory 6200 is configured to store executable instructions; the instructions are used to control the processor 6400 to implement the above-mentioned metering and charging method for cloud computing.

In the embodiment, the electronic device 6000 may be any electronic products that have a memory 6200 and a processor 6400, such as a cell phone, a tablet, a pda, a desktop, a laptop, a workstation, a game console, and the like.

According to yet another embodiment of the present application, a computer-readable storage medium is provided, on which a computer program is stored. The computer program, when executed by a processor, implements any of the metering and charging methods for cloud computing in any embodiment of the present application.

In yet another embodiment of the present application, a computer program product containing instructions is provided. When running on a computer, the computer program product implements any of the metering and charging methods for cloud computing in any embodiment of the present application.

The present application can be a system, method and/or computer program product. The computer program product may include a computer-readable storage medium loaded with computer-readable program instructions for enabling a processor to implement various aspects of the present application.

The computer-readable storage medium may be a tangible device that can hold and store instructions used by the instruction execution device. The computer-readable storage medium may include, but is not limited to, an electrical storage device, a magnetic storage device, an optical storage device, an electromagnetic storage device, a semiconductor storage device, or any suitable combination thereof, for example. More specific examples (non-exhaustive list) of computer-readable storage media include: portable computer disks, hard disks, random access memory (RAM), read-only memory (ROM), erasable programmable read-only memory (EPROM Or flash memory), static random access memory (SRAM), portable compact disk read-only memory (CD-ROM), digital versatile disk (DVD), memory stick, floppy disk, mechanical encoding device, such as a punch card or a protruding structure in groove on which instructions are stored, and any suitable combination thereof. The computer-readable storage medium used herein is not interpreted as a transient signal itself, such as radio waves or other freely propagating electromagnetic waves, electromagnetic waves propagating through waveguides or other transmission media (for example, light pulses through fiber optic cables), or electrical signals transmitted through wire transmission.

The computer-readable program instructions described herein can be downloaded from a computer-readable storage medium to various computing/processing devices, or downloaded to an external computer or external storage device via a network, such as the Internet, a local area network, a wide area network, and/or a wireless network. The network may include copper transmission cables, optical fiber transmission, wireless transmission, routers, firewalls, switches, gateway computers, and/or edge servers. The network adapter card or network interface in each computing/processing device receives computer-readable program instructions from the network and forwards the computer-readable program instructions for storage in a computer-readable storage medium in each computing/processing device.

The computer program instructions used to perform the operations of the present application may be compilation instructions, instruction set architecture (ISA) instructions, machine instructions, machine-related instructions, microcode, firmware instructions, status setting data, or source code or object code written in any combination of one or more programming languages, including object-oriented programming languages such as Smalltalk, C++, etc., and conventional procedural programming languages such as “C” language or similar programming languages. Computer-readable program instructions can be executed entirely on a computer of a user, partly on a computer of a user, executed as a stand-alone software package, partly on a computer of a user and partly executed on a remote computer, or entirely on a remote computer or server. In the case of a remote computer, the remote computer can be connected to the computer of the user through any kind of network, including a local area network (LAN) or a wide area network (WAN), or it can be connected to an external computer (for example, using an Internet service provider to connect via the Internet). In some embodiments, an electronic circuit, such as a programmable logic circuit, a field programmable gate array (FPGA), or a programmable logic array (PLA), can be customized by using the status information of the computer-readable program instructions. The electronic circuit can execute computer-readable program instructions to realize various aspects of the present application.

Various aspects of the present application are described herein with reference to the flowcharts and/or block diagrams of the methods, apparatuses (systems) and computer program products according to the embodiments of the present application. It should be understood that each block of the flowcharts and/or block diagrams, and combinations of blocks in the flowcharts and/or block diagrams, can be implemented by computer-readable program instructions.

These computer-readable program instructions can be provided to the processors of general-purpose computers, special-purpose computers, or other programmable data processing devices, so as to produce a machine that makes these instructions, when executed by the processor of the computer or other programmable data processing devices, generate a device that implements the functions/actions specified in one or more blocks in the flowcharts and/or block diagrams. These computer-readable program instructions may also be stored in a computer-readable storage medium. These instructions cause computers, programmable data processing devices, and/or other devices work in a specific manner. Thus, the computer-readable medium storing the instructions includes an article of a manufacture, which includes instructions for implementing various aspects of the functions/actions specified in one or more blocks in the flowcharts and/or block diagrams.

Computer-readable program instructions may also be loaded onto a computer, other programmable data processing device, or other equipment, so that a series of operation steps are executed on the computer, other programmable data processing device, or other equipment to produce a computer-implemented process, so that the instructions executed on the computer, other programmable data processing device, or other equipment realize the functions/actions specified in one or more blocks in the flowcharts and/or block diagrams.

The flowcharts and block diagrams in the accompanying drawings show the possible implementation architecture, functions, and operations of the system, method, and computer program product according to multiple embodiments of the present application. In this regard, each block in the flowchart or block diagram may represent a module, program segment, or part of an instruction, and the module, program segment, or part of an instruction contains one or more executable instructions for realizing the specified logic function. In some alternative implementations, the functions marked in the blocks may also occur in a different order than the order marked in the drawings. For example, two consecutive blocks can actually be executed substantially in parallel, or they can sometimes be executed in the reverse order, depending on the functions involved. It should also be noted that each block in the block diagrams and/or flowcharts, and the combination of the blocks in the block diagrams and/or flowcharts, can be implemented by a dedicated hardware-based system that performs specified functions or actions, or it can be realized by a combination of dedicated hardware and computer instructions. It is well known to those skilled in the art that implementation through hardware, implementation through software, and implementation through a combination of software and hardware are all equivalent.

The embodiments of the present application have been described above, and the above description is exemplary, not exhaustive, and is not limited to the disclosed embodiments. Without departing from the scope and spirit of the described embodiments, many modifications and changes are obvious to those of ordinary skill in the art. The choice of terms used herein is intended to best explain the principles of the various embodiments, practical applications, or technical improvements in the market, or to enable other skilled in the art to understand the various embodiments disclosed herein. The scope of the application is defined by the appended claims.

### INDUSTRIAL APPLICABILITY

Based on the cloud computing metering method, apparatus, electronic device, and storage medium provided by the embodiments of the present application, users who are sensitive to costs do not need to unsubscribe the cloud host instance when they want to shut down the instance, nor do they need to re-order and re-install all software systems when they want to restart it, such that the users can really shut it down when they want to shut down, and restart it when they want to restart, thus minimizing the bill fees for users to use cloud host instances. This not only improves the user experience, but also enables cloud host providers to attract more users, and maintain and improve the sales of storage and network resources while maximizing the sales ratio of physical machines.

What is claimed is:

1. A metering and charging method for cloud computing, comprising:
obtaining an identifier of a cloud host instance to be charged;
obtaining, according to the identifier, a data record set corresponding to the identifier; wherein each data record included in the data record set comprises instance configuration information, an instance change time, and an instance change type of the cloud host instance;
for each data record, determining a charging duration according to the instance change time in the data record; and
in the case that the instance change type in the data record is instance shutdown, performing charging processing on charging items in the instance configuration information according to the charging duration, wherein the charging items do not comprise charging items corresponding to computing resources.

2. The method according to claim 1, wherein, determining a charging duration according to the instance change time in the data record comprises:
determining whether the instance change time in the data record is prior to a start time of a previous billing period;
determining a charging start time according to a determination result;
determining a data record in the data record set with an instance change time later than the instance change time of the data record and with the earliest instance change time in the data record set as a second data record;
determining an instance change time in the second data record as a charging end time;
determining a difference between the end time and the charging start time as the charging duration.

3. The method according to claim 2, wherein determining a charging start time according to a determination result comprises:
in the case that the determination result is that the instance change time in the data record is prior to the start time of the previous billing period, determining the start time of the previous billing period as the charging start time;
in the case that the determination result is that the instance change time in the data record is later than or equal to the start time of the previous billing period, determining the instance change time in the data record as the charging start time.

4. The method according to claim 1, wherein before obtaining an identifier of a cloud host instance to be charged, the method further comprises:
obtaining an identifier, instance configuration information, an instance change time, and an instance change type of the cloud host instance;
generating a data record according to the identifier, the instance configuration information, the instance change time and the instance change type;
storing the data record.

5. The method according to claim 4, wherein the instance change type comprises at least one of instance activation, instance shutdown, instance startup, instance reconfiguration and instance unsubscription.

6. The method according to claim 4, wherein generating a data record according to the identifier, the instance configuration information, the instance change time and the instance change type comprises at least one of the following:
in the case that the instance change type is instance activation, using the identifier as a key, the instance configuration information as a value, an instance activation time as the instance change time, and instance activation as the instance change type to generate a data record;
in the case that the instance change type is instance shutdown, using the identifier as a key, the instance configuration information as a value, an instance shutdown time as the instance change time, and instance shutdown as the instance change type to generate a data record, wherein the instance configuration information is instance configuration information in a data record with the latest instance change time obtained by querying a local database based on the identifier;
in the case that the instance change type is instance startup, using the identifier as a key, the instance configuration information as a value, an instance startup time as the instance change time, and instance startup as the instance change type to generate a data record, wherein the instance configuration information is instance configuration information in a data record with the latest instance change time obtained by querying the local database based on the identifier;
in the case that the instance change type is the instance reconfiguration, using the identifier as a key, the instance configuration information as a value, an instance configuration change time as the instance change time, and instance reconfiguration as the instance change type to generate a data record;
in the case that the instance change type is instance unsubscription, using the identifier as a key, the instance configuration information as a value, an instance unsubscription time as the instance change time, and instance unsubscription as the instance change type to generate a data record, wherein the instance configuration information is a null value.

7. The method according to claim 4, wherein, obtaining the instance configuration information of the cloud host instance comprises:
in the case that the instance change type is instance activation or instance reconfiguration, obtaining the instance configuration information through an order server;
in the case that the instance change type is instance startup or instance shutdown, obtaining a data record with the latest instance change time by querying a local database based on the identifier, and using instance configuration information in the data record with the latest instance change time as the instance configuration information.

8. A metering and charging apparatus for cloud computing, comprising:
a first obtaining module, configured to obtain an identifier of a cloud host instance to be charged;
a second obtaining module, configured to obtain, according to the identifier, a data record set corresponding to the identifier; wherein each data record included in the data record set comprises instance configuration information, an instance change time, and an instance change type of the cloud host instance;
a determining module, configured to determine, for each data record, a charging duration according to the instance change time in the data record;
a charging module, configured to perform charging processing on charging items in the instance configuration information according to the charging duration in the case that the instance change type in the data record is instance shutdown, wherein the charging items do not comprise charging items corresponding to computing resources.

9. The apparatus according to claim 8, wherein the determining module determining, for each data record, a charging duration according to the instance change time in the data record comprises:
determining whether the instance change time in the data record is prior to a start time of a previous billing period;
determining a charging start time according to a determination result;
determining a data record in the data record set with an instance change time later than the instance change time of the data record and with the earliest instance change time in the data record set as a second data record;
determining an instance change time in the second data record as a charging end time;
determining the difference between the end time and the charging start time as the charging duration.

10. The apparatus according to claim 9, wherein the determining module determining a charging start time according to a determination result comprises:
in the case that the determination result is that the instance change time in the data record is prior to the start time of the previous billing period, determining the start time of the previous billing period as the charging start time;
in the case that the determination result is that the instance change time in the data record is later than or equal to the start time of the previous billing period, determining the instance change time in the data record as the charging start time.

11. The apparatus according to claim 8, wherein the apparatus further comprises:
a third obtaining module, configured to obtain an identifier, instance configuration information, an instance change time and an instance change type of the cloud host instance;
a generating module, configured to generate a data record according to the identifier, the instance configuration information, the instance change time and the instance change type;
a storage module, configured to store the data record.

12. The apparatus according to claim 11, wherein the instance change type comprises at least one of instance activation, instance shutdown, instance startup, instance reconfiguration and instance unsubscription.

13. The apparatus according to claim 11 or 12, wherein the generating module generating a data record according to the identifier, the instance configuration information, the instance change time and the instance change type comprises at least one of following:
in the case that the instance change type is instance activation, using the identifier as a key, the instance configuration information as a value, an instance activation time as the instance change time, and instance activation as the instance change type to generate a data record;
in the case that the instance change type is instance shutdown, using the identifier as a key, the instance configuration information as a value, an instance shutdown time as the instance change time, and instance shutdown as the instance change type to generate a data record, wherein the instance configuration information is instance configuration information in a data record with the latest instance change time obtained by querying a local database based on the identifier;
in the case that the instance change type is instance startup, using the identifier as a key, the instance configuration information as a value, an instance startup time as the instance change time, and the instance startup as the instance change type to generate a data record, wherein the instance configuration information is instance configuration information in a data record with the latest instance change time obtained by querying the local database based on the identifier;
in the case that the instance change type is the instance reconfiguration, using the identifier as a key, the instance configuration information as a value, an instance configuration change time as the instance change time, and instance reconfiguration as the instance change type to generate a data record;
in the case that the instance change type is instance unsubscription, using the identifier as a key, the instance configuration information as a value, an instance unsubscription time as the instance change time, and instance unsubscription as the instance change type to generate a data record, wherein the instance configuration information is a null value.

14. The apparatus according to claim 11, wherein the third obtaining module obtaining the instance configuration information of the cloud host instance comprises:
in the case that the instance change type is instance activation or instance reconfiguration, obtaining the instance configuration information through an order server;
in the case that the instance change type is instance startup or instance shutdown, obtaining a data record with the latest instance change time by querying a local database based on the identifier, and using instance configuration information in the data record with the latest instance change time as the instance configuration information.

15. An electronic device, comprising:
a processor and a memory, the memory is configured to store executable instructions, and the instructions are used to control the processor to execute the metering and charging method for cloud computing according to claim 1.

16. A computer-readable storage medium, on which a computer program is stored, the computer program, when executed by a processor, implements the metering and charging method for cloud computing according to claim 1.

17. A non-transitory computer program product, when running on a computer, causing the computer to implement the metering and charging method for cloud computing according to claim 1.
